(19) United States
(12) Patent Application Publication
(10) Pub. No.: US 2011/0298592 A1
(43) Pub. Date: Dec. 8, 2011

(54) RFID APPARATUS AND CONTROL METHOD OF SAME

(75) Inventor: Makoto Sugiyama, Singapore (SG)

(73) Assignee: TOSHIBA TEC KABUSHIKI KAISHA, Tokyo (JP)

(21) Appl. No.: 13/053,457

(22) Filed: Mar. 22, 2011

(30) Foreign Application Priority Data
Jun. 4, 2010 (JP) 2010-129366

(51) Int. Cl. H04Q 5/22

(52) U.S. Cl. 340/10.51; 340/10.1

(57) ABSTRACT

A radio frequency identification (RFID) apparatus includes a radio communication unit, a scanning unit, an analyzing unit, and a setting unit. The radio communication unit is configured to transmit and receive radio waves. The scanning unit is configured to control the radio communication unit to scan radio waves by receiving a received radio wave outputted from an external radio communication unit. The analyzing unit is configured to analyze the received radio wave to determine an in-use frequency band of the received radio wave of the external radio communication unit. The setting unit is configured to set a frequency band of a radio wave for use in the RFID apparatus to the in-use frequency band of the received radio wave of the external radio communication unit.

### CROSS-REFERENCE TO RELATED APPLICATIONS

This application is based upon and claims the benefit of priority from Japanese Patent Application No. 2010-129366, filed on Jun. 4, 2010, the entire contents of which are incorporated herein by reference.

### FIELD

Embodiments described herein relate to an RFID apparatus having an RFID reader/writer function, an RFID apparatus control method, and a computer-readable storage medium storing a program for controlling an RFID apparatus.

### BACKGROUND

Frequency bands of a radio wave available for use in radio frequency identification (RFID) apparatuses such as RFID reader/writers are different depending on the country or region where the RFID apparatuses are currently used. For such RFID apparatuses to be used in different countries or regions, users or operators may need to manually modify a setting of the frequency band of radio wave in the RFID apparatuses according to the relevant standards of the countries or regions.

When a user or operator manually modifies a setting of the frequency band of a radio wave in an RFID apparatus, however, such modification may be time consuming and be subject to a risk of causing a setting error. Therefore, it is highly recommended that this modification is automatically performed according to an available frequency band of radio wave in each country or region.

### BRIEF DESCRIPTION OF THE DRAWINGS

FIG. 1 is a schematic block diagram showing a configuration of a radio frequency identification (RFID) tag.

FIG. 2 is a schematic block diagram showing a configuration of an RFID tag reader/writer as one embodiment of an RFID apparatus.

FIG. 3 illustrates frequency bands of radio wave available for use in RFID apparatuses in some countries or regions of the world.

FIG. 4 is a flowchart showing a control process of automatically setting a frequency band of a radio wave available for use in an RFID apparatus.

FIG. 5 is a diagram showing the spectrum of output radio waves that may be detected when an RFID apparatus such as an RFID tag reader/writer is being operated in the Republic of Korea.

### DETAILED DESCRIPTION

According to one embodiment, a radio frequency identification (RFID) apparatus includes a radio communication unit, a scanning unit, an analyzing unit, and a setting unit. The radio communication unit is configured to transmit and receive radio waves. The scanning unit is configured to control the radio communication unit to scan radio waves by receiving a received radio wave outputted from an external radio communication unit. The analyzing unit is configured to analyze the received radio wave to determine an in-use frequency band of the received radio wave of the external radio communication unit. The setting unit is configured to set a frequency band of a radio wave for use in the RFID apparatus to the in-use frequency band of the received radio wave of the external radio communication unit.

Exemplary embodiments will now be described in detail with reference to the accompanying drawings.

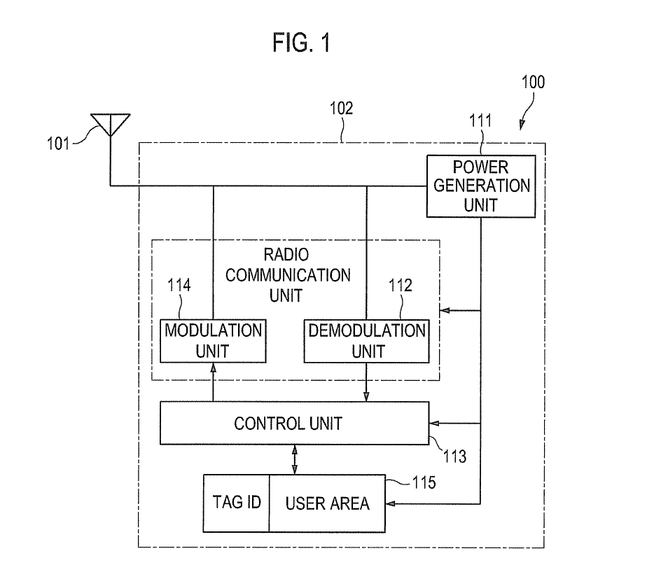

With reference to FIG. 1, a configuration of a radio frequency identification (RFID) tag is described. FIG. 1 is a schematic block diagram showing a configuration of an RFID tag 100. As shown in FIG. 1, the RFID tag 100 includes an antenna 101 and an integrated circuit (IC) chip 102. Although the antenna 101 is shown in FIG. 1 to be included in the RFID tag 100, in actual implementation, the antenna 101 may be embedded in the RFID tag 100 or attached to the outside of the RFID tag 100.

The IC chip 102 includes a power generation unit 111, a radio communication unit including a demodulation unit 112 and a modulation unit 114, a control unit 113, and a storage unit 115. The power generation unit 111 is configured to rectify and stabilize modulated radio waves received through the antenna 101, thereby generating and supplying electric power to the respective components of the IC chip 102. The demodulation unit 112 of the radio communication unit is configured to demodulate the modulated radio wave to forward the demodulated data to the control unit 113. The modulation unit 114 of the radio communication unit is configured to modulate data sent from the control unit 113 to transmit the modulated data to the antenna 101. The control unit 113 is configured to write into the storage unit 115 the demodulated data from the demodulation unit 112 and read data from the storage unit 115 to send the same to the modulation unit 114. The storage unit 115 may be implemented using a non-volatile rewritable component such as an EEPROM (Electrically Erasable Programmable Read Only Memory). The storage unit 115 is configured to store in advance an ID as unique identification information, which is assigned and set by a manufacturer during a process of fabricating the RFID tag 100. The storage unit 115 includes a user area into which data may be written by a user or operator. Although the antenna 101 is shown in FIG. 1 as being attached to the outside of the IC chip 102, it may be embedded in the IC chip 102 as a part of the radio communication unit including the demodulation unit 112 and the modulation unit 114.

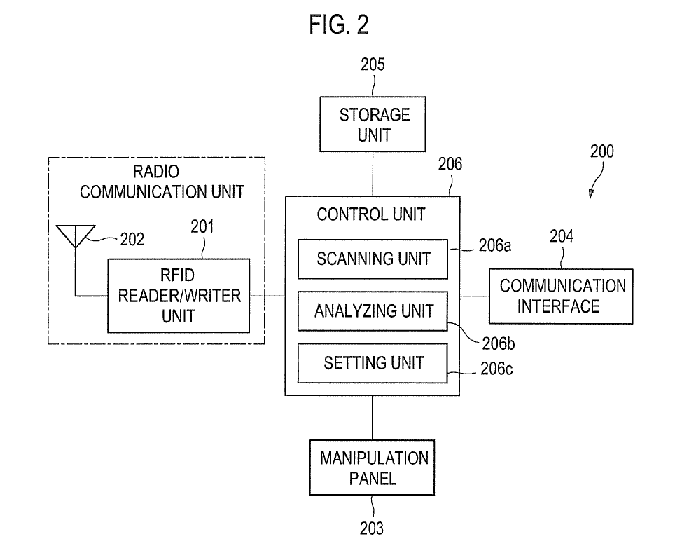

With reference to FIG. 2, a configuration of an RFID tag reader/writer according to one embodiment will be described. FIG. 2 is a schematic block diagram showing a configuration of an RFID tag reader/writer 200. The RFID tag reader/writer 200 is configured to perform a data read operation and a data write operation with respect to the RFID tag 100. As shown in FIG. 2, the RFID tag reader/writer 200 includes a radio communication unit, a manipulation panel 203, a communication interface 204, a storage unit 205, and a control unit 206. The radio communication unit includes an RFID reader/writer unit 201 and an antenna unit 202.

The antenna unit 202 of the radio communication unit is configured to transmit modulated radio wave as a data read/write signal and receive modulated radio waves sent from the RFID tag 100 in response to the modulated radio waves transmitted from the antenna unit 202, under the control of the RFID reader/writer unit 201. The data read/write signal is transmitted from the RFID tag reader/writer 200 to the RFID tag 100 when a data read operation or a data write operation is performed with respect to the RFID tag 100. By sending the data read/write signal, the RFID reader/writer unit 201 of the radio communication unit is configured to read and write data from/to the storage unit 115 of the RFID tag 100, which is positioned within an area that a modulated radio wave from the antenna unit 202 can reach.

The manipulation panel 203 includes, for example, function keys and a display panel. The communication interface 204 is configured to be connected to a plurality of external devices. An operator may manipulate operations of the RFID tag reader/writer 200 through the manipulation panel 203 or a host device (not shown) that is connected to the communication interface 204.

The storage unit 205 is configured to store a control program for controlling the RFID tag reader/writer 200 and RFID write data. The RFID write data may be information to be written into the user area in the storage unit 115 of the RFID tag 100. The storage unit 205 may be a memory device such as a flash memory or an SRAM (Static Random Access Memory).

The control unit 206 is configured to control operations of the RFID reader/writer unit 201, the manipulation panel 203, the communication interface 204, and the storage unit 205. Upon receiving an RFID issuance job from the host device (not shown) through the communication interface 204, the control unit 206 stores RFID write data contained in the RFID issuance job into the storage unit 205. The control unit 206 includes a scanning unit 206a, an analyzing unit 206b, and a setting unit 206c. The scanning unit 206a, the analyzing unit 206b, and the setting unit 206c may be implemented in software, hardware, or a combination thereof. The scanning unit 206a is configured to control the radio communication unit (or the RFID reader/writer unit 201) to perform a scanning of radio waves by receiving a radio wave outputted from an external radio communication unit. The analyzing unit 206b is configured to analyze the received radio wave, thereby determining a frequency band of the received radio wave. The setting unit 206c is configured to set a frequency band of the radio wave for use in the RFID tag reader/writer 200 based on the frequency band determined by the analyzing unit 206b.

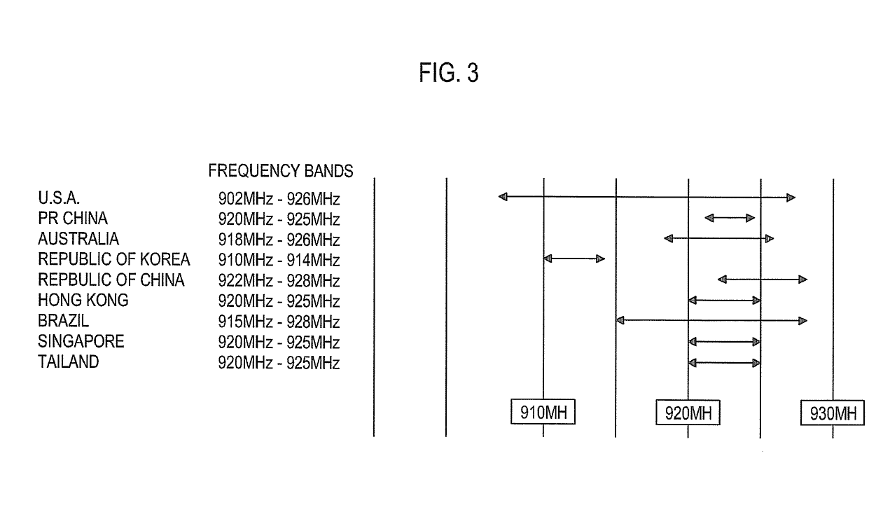

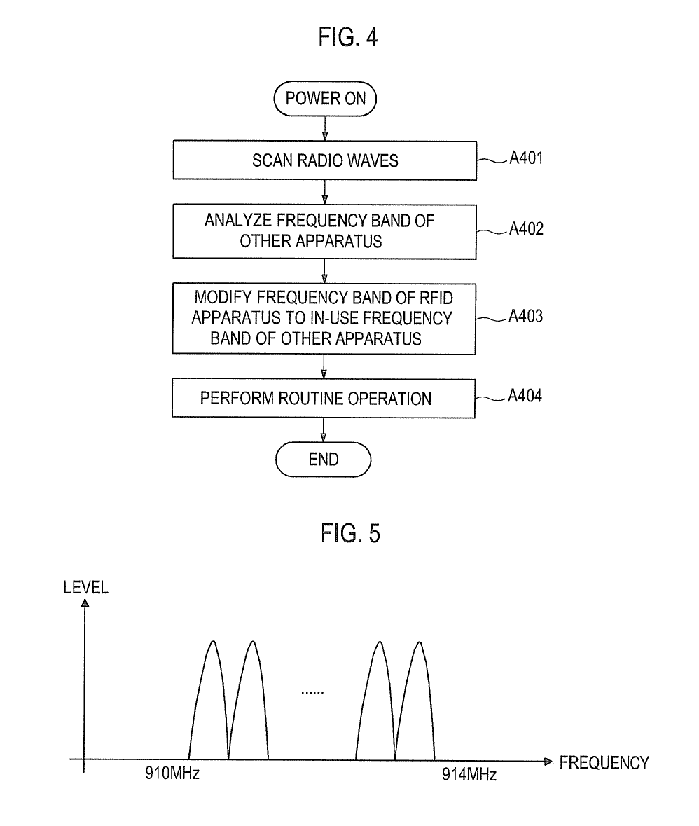

As shown in FIG. 3, a frequency band available for radio communication between the RFID tag 100 and the RFID reader/writer unit 201 may be considered as usable or unusable according to relevant regulations provided by each county. For this reason, the radio communication between the RFID tag 100 and the RFID reader/writer unit 201 may be required to set a frequency band of the radio wave according to the regulations provided in the country where the radio communication is performed (hereinafter referred to as “service country”). Hereinafter, with reference to FIG. 4, a control process of automatically setting a frequency band of the radio wave, which sets a frequency band for use in radio communication between the RFID tag 100 and the RFID reader/writer unit 201 to a usable frequency band of the radio wave in compliance with the regulations of the service country. FIG. 4 is a flowchart showing the control process of setting a frequency band of the radio wave in the RFID tag reader/writer 200.

The control process to be describe below may be performed through the control unit 206 (e.g., the scanning unit 206a, the analyzing unit 206b, and the setting unit 206c) under the control of a control program which is stored in the storage unit 205 and executed by the control unit 206. In the present disclosure, the RFID tag reader/writer 200 is described as an example of a RFID apparatus, but it is not limited thereto. For example, the automatic setting control process of the present disclosure may also be performed in an RFID apparatus such as an RFID label issuing apparatus. The RFID label issuing device may include an RFID reader/writer unit configured to perform a data read operation and a data write operation with respect to an RFID tag contained in an RFID label, and a printer unit configured to print label data on a print surface of the RFID label.

In one embodiment, when the RFID tag reader/writer 200 is powered on, the scanning module 206a of the control unit 206 controls the RFID reader/writer unit 201 to scan radio waves by receiving a received radio wave outputted from an external RFID apparatus through the antenna 202 (Act A401).

If the RFID reader/writer unit 201 detects the radio wave outputted from the external RFID apparatus (e.g., other RFID tag reader/writer, hereinafter referred to as “other apparatus”), the analyzing unit 206b of the control unit 206 analyzes the detected radio wave to determine a frequency band (hereinafter referred to as “an in-use frequency band”) of the radio wave, which is currently used in the other apparatus (Act A402). For example, if an RFID apparatus such as an RFID tag reader/writer is under operation in the Republic of Korea, an in-use frequency band of the radio wave (ranging from 910 MHz to 914 MHz) as shown in FIG. 5 may be detected.

And then, the setting unit 206c of the control unit 206 sets a frequency band of the radio wave of the RFID reader/writer unit 201 to the in-use frequency band of the radio wave of the other apparatus, which is determined in Act A402 (Act A403). In this way, the frequency band of the radio wave for use in the RFID reader/writer unit 201 is automatically modified and set to the in-use frequency band of the radio wave of the other apparatus.

Thereafter, based on the newly set frequency band of the radio wave, the RFID tag reader/writer 200 performs routine operations, e.g., operations for reading data from the RFID tag 100 and writing data thereinto (Act A404).

The above-described automatic setting control process is presented by way of an example, but it is not limited thereto. For example, as described above with reference to FIG. 4, the control process of automatically setting the frequency band of radio wave is commenced when the RFID tag reader/writer 200 is powered on. In some embodiments, once the RFID tag reader/writer 200 has performed the control process to set the in-use frequency band, the control process may not be resumed until a specific instruction (e.g., a reset instruction) is input by a user or operator through the manipulation panel 203 or the communication interface 204. Alternatively, after the RFID tag reader/writer 200 is powered on, the control process may not be commenced until a specific instruction is input (e.g., by pressing a button designated to commence the control process) or a reset instruction is input.

If no other apparatus is under operation, the control process of automatically setting a frequency band of radio waves may not be completed. In this case, a frequency band of radio waves for use in the RFID tag reader/writer 200, however, may be set by commencing the automatic setting control process by operating the other apparatus whose frequency band of radio waves is already set to the usable frequency band of radio waves in compliance with the regulations of the service country. Also, if the RFID tag reader/writer 200 according to the above embodiment is additionally operated during radio communication between RFID tags and other RFID apparatuses under operation, the control process of automatically setting a frequency band of radio waves can be instantaneously completed.

In accordance with the above-described embodiment, a frequency band of a radio wave for use in an RFID apparatus such as the RFID tag reader/writer 200, which may be different depending on the service country, may be realized automatically not manually.

The processes, which are shown in FIG. 4 and performed in the RFID tag reader/writer 200, may be provided in advance as a control program in a non-volatile memory such as a flash memory of the storage unit 205. The control program may be executed by the control unit 206 of the RFID tag reader/writer 200. Also, the control program may be provided in the form of an installable or executable file that is recorded on a computer-readable recording medium such as, for example, a CD-ROM (Compact Disk Read Only Memory), an FD (Flexible Disk), a CD-R (Compact Disk Recordable), a DVD (Digital Versatile Disk), or a removable memory. Also, the control program may be installed in the storage unit 205 of the RFID tag reader/writer 200 through a program reader or a program host. Further, if the control program is stored in a computer connected to a network such as an Internet, it may be downloaded from the program host through the network to be installed in the storage unit 205 of the RFID tag reader/writer 200.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus, and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) or the like in the apparatus.

While certain embodiments have been described above, these embodiments have been presented by way of example only, and are not intended to limit the scope of the inventions. Indeed, the novel RFID apparatuses and the novel control processes described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A radio frequency identification (RFID) apparatus, comprising:
a radio communication unit configured to transmit and receive radio waves;
a scanning unit configured to control the radio communication unit to scan radio waves by receiving a received radio wave outputted from an external radio communication unit;
an analyzing unit configured to analyze the received radio wave to determine an in-use frequency band of the received radio wave of the external radio communication unit; and
a setting unit configured to set a frequency band of a radio wave for use in the RFID apparatus to the in-use frequency band of the received radio wave of the external radio communication unit.

2. The apparatus of claim 1, wherein the scanning unit, the analyzing unit, and the setting unit are triggered to perform their operations when the RFID apparatus is powered on.

3. The apparatus of claim 1, wherein the RFID apparatus is an RFID tag reader/writer configured to perform a data read operation and a data write operation with respect to an RFID tag.

4. The apparatus of claim 1, further comprising a storage unit configured to store RFID write data and a control program for controlling operations of the scanning unit, the analyzing unit, and the setting unit.

5. The apparatus of claim 1, further comprising a manipulation panel and a communication interface configured to receive instructions from an operator to manipulate operations of the RFID apparatus.

6. The apparatus of claim 5, wherein the scanning unit, the analyzing unit, and the setting unit are triggered to perform their operations upon receiving the instructions from the operator through the manipulation panel or the communication interface.

7. A method of controlling an RFID apparatus including a radio communication unit, the method comprising:
transmitting and receiving radio waves through the radio communication unit;
controlling the radio communication unit to perform a scanning of radio waves by receiving a received radio wave outputted from an external radio communication unit;
analyzing the received radio wave to determine an in-use frequency band of the external radio-communication unit; and
setting a frequency band of a radio wave for use in the RFID apparatus to the in-use frequency band of the received radio wave of the external radio communication unit.

8. The method of claim 7, wherein transmitting and receiving of radio waves, controlling the radio communication unit, analyzing the received radio wave, and setting a frequency band of a radio wave are triggered to begin by powering on the RFID apparatus.

9. The method of claim 7, further comprising performing a data read operation and a data write operation with respect to an RFID tag.

10. The method of claim 7, further comprising receiving instructions from an operator to manipulate operations of the RFID apparatus.

11. The method of claim 10, wherein the instructions received from the operator triggers transmitting and receiving radio waves, controlling the radio communication unit, analyzing the received radio wave, and setting a frequency band of a radio wave.

12. A computer-readable storage medium storing instructions that, when executed by a computer, cause the computer to perform the operations of:
transmitting and receiving radio waves through a radio communication unit included in an RFID apparatus;
controlling the radio communication unit to perform a scanning of radio waves by receiving a received radio wave outputted from an external radio communication unit;
analyzing the received radio wave to determine an in-use frequency band of the external radio communication unit; and
setting a frequency band of a radio wave for use in the RFID apparatus to the in-use frequency band of the received radio wave of the external radio communication unit.

13. The medium of claim 12, wherein the instructions are triggered to begin by powering on the RFID apparatus.

14. The medium of claim 12, further comprising performing a data read operation and a data write operation with respect to an RFID tag.

15. The medium of claim 12, further comprising receiving commands from an operator to manipulate operations of the RFID apparatus.

16. The medium of claim 15, wherein the commands received from the operator triggers the instructions.
